(19) United States
(12) Patent Application Publication
(10) Pub. No.: US 2019/0074881 A1
(43) Pub. Date: Mar. 7, 2019

(54) ELECTROMECHANICALLY RECONFIGURABLE COHERENT BEAMFORMING

(71) Applicant: Elwha LLC, Bellevue, WA (US)

(72) Inventor: Yaroslav Urzhumov, Bellevue, WA (US)

(21) Appl. No.: 16/102,082

(22) Filed: Aug. 13, 2018

Related U.S. Application Data
(60) Provisional application No. 62/546,823, filed on Aug. 17, 2017.

(51) Int. Cl. H04B 7/06; G01S 7/52

(52) U.S. Cl. CPC H04B 7/0617; G01S 7/52095

(57) ABSTRACT

According to various embodiments, systems and methods for beamforming feed waves. An apparatus can include a reconfigurable arrangement of a first beamforming component and a second beamforming component. The first beamforming component can be configured to convert feed waves from a feed source into one or more intermediate beam patterns. The second beamforming component can be configured to convert the one or more intermediate beam patterns received at the second beamforming component from the first beamforming component into one or more output beam patterns based on one or more beamforming component configuration states of the reconfigurable arrangement.

### CROSS-REFERENCE TO RELATED APPLICATIONS

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc., applications of such applications are also incorporated by reference, including any priority claims made in those applications and any material incorporated by reference, to the extent such subject matter is not inconsistent herewith.

The present application claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority Application(s)).

### Priority Applications:

This application claims priority under 35 U.S.C. § 119(e) to Provisional Patent App. No. 62/546,823, filed on Aug. 17, 2017, titled “Electromechanically Reconfigurable Diffractive Beamforming Metasurfaces,” which application is hereby incorporated by reference in its entirety.

### TECHNICAL FIELD

The present disclosure generally relates to beamforming, and more particularly, to systems and methods for using electromechanically reconfigurable beamforming components to perform coherent beamforming of wave radiation.

### BACKGROUND

Coherent beamforming of wave radiation is a general wave dynamics concept with wide applicability in different applications. For example, coherent beamforming of wave radiation can be used in remote sensing, wireless communications, electronic warfare and directed energy weapons. With respect to radio frequency wave radiation, Electronically-Steerable Arrays (ESAs) have been developed to perform coherent beamforming. However, current ESAs approach the theoretical limits of beamforming efficiency and enable arbitrary beamforming, with beam pattern switching times in the microsecond range or faster. Further, current ESAs are prohibitively expensive, in particular for applications that require high directivity or beam pattern focusing at a sufficient range. For example, even “passive” (lacking distributed amplification) implementations of ESAs based on digital T/R modules typically have poor cost density, on the order of $1000 per square wavelength (λ²) of the aperture area. There therefore exists needs for improved beamforming systems and methods for meeting increasing operational limits required for current and new beamforming applications while still remaining feasible to implement from a cost perspective.

Metasurface/metamaterial-based ESAs have been created to replace an array of isolated digital T/R modules with a distribution of smaller, cheaper, analog-modulation elements, resulting in much more cost-efficient reconfigurable beamforming solutions. Such metasurface ESAs are advantageous due to their low-profile form-factors—easily less than half-wavelength in thickness above a mounting surface—and the potential to be conformal to a wide range of surfaces. However, due to a very large number of modulation elements, control lines and digital controlling elements, cost density of these types of solutions remains prohibitively high for applications demanding enormous directivity or range. There therefore exists needs for metasurface ESAs that meet increasing operational limits required for current and new beamforming applications, while still remaining feasible to implement from a cost perspective.

### SUMMARY

According to various embodiments, an apparatus for beamforming feed waves can include a reconfigurable arrangement of a first beamforming component and a second beamforming component. The first beamforming component can be configured to convert feed waves from a feed source into one or more intermediate beam patterns. The second beamforming component can be configured to convert the one or more intermediate beam patterns received at the second beamforming component from the first beamforming component into one or more output beam patterns based on one or more beamforming component configuration states of the reconfigurable arrangement.

In various embodiments, an apparatus for beamforming feed waves can include a reconfigurable arrangement of a first beamforming component and a second beamforming component. The first beamforming component can be configured to convert feed waves from a feed source into one or more intermediate beam patterns. The second beamforming component can be configured to convert the one or more intermediate beam patterns received at the second beamforming component from the first beamforming component into one or more output beam patterns based on one or more beamforming component configuration states of the reconfigurable arrangement. Specifically, the first beamforming component can be reconfigurable to achieve different first beamforming component configuration states of the reconfigurable arrangement to convert the feed waves into the one or more intermediate beam patterns based on the different first beamforming component configuration states. Further, the second beamforming component can be reconfigurable to achieve different second beamforming component configuration states of the reconfigurable arrangement to convert the one or more intermediate beam patterns into the one or more output beam patterns based on the different second beamforming component configuration states. Each first beamforming component configuration state can correspond to a frequency-domain mode for the first beamforming component and each second beamforming component configuration state can correspond to a frequency-domain mode for the second beamforming component of one or more frequencies of the feed waves.

In certain embodiments, an apparatus for beamforming feed waves can include a reconfigurable arrangement of a first beamforming component, a second beamforming component and a third beamforming component. The first beamforming component can be configured to convert feed waves from a feed source into one or more intermediate beam patterns. The second beamforming component can be configured to convert the one or more intermediate beam patterns received at the second beamforming component from the first beamforming component into one or more output beam patterns based on one or more beamforming component configuration states of the reconfigurable arrangement. Further, the third beamforming component can be configured to convert the one or more output beam patterns received at the third beamforming component from the second beamforming component into one or more beam patterns based on different third beamforming component configuration states of the third beamforming component as part of the one or more beamforming component configuration states of the reconfigurable arrangement.

In various embodiments, a method for beamforming feed waves can include controlling a reconfigurable arrangement of a first beamforming component and a second beamforming component. Specifically, the reconfigurable arrangement can be controlled to form one or more output beam patterns from the feed waves based on one or more beamforming component configuration states of the reconfigurable arrangement. In controlling the reconfigurable arrangement to form the output beam patterns, the first beamforming component can be controlled to convert the feed waves received at the first beamforming component from a feed source into one or more intermediate beam patterns. Further, in controlling the reconfigurable arrangement to form the output beam patterns, the second beamforming component can be controlled to convert the one or more intermediate beams received at the second beamforming component from the first beamforming component into the one or more output beam patterns based on the reconfigurable arrangement.

In certain embodiments, a method for beamforming feed waves can include controlling a reconfigurable arrangement of a first beamforming component and a second beamforming component. Specifically, the reconfigurable arrangement can be controlled to form one or more output beam patterns from the feed waves based on one or more beamforming component configuration states of the reconfigurable arrangement. In controlling the reconfigurable arrangement to form the output beam patterns, the first beamforming component can be controlled to convert the feed waves received at the first beamforming component from a feed source into one or more intermediate beam patterns. Further, in controlling the reconfigurable arrangement to form the output beam patterns, the second beamforming component can be controlled to convert the one or more intermediate beams received at the second beamforming component from the first beamforming component into the one or more output beam patterns based on the reconfigurable arrangement. Specifically, the first beamforming component can be reconfigurable to achieve different first beamforming component configuration states of the reconfigurable arrangement to convert the feed waves into the one or more intermediate beam patterns based on the different first beamforming component configuration states. Further, the second beamforming component can be reconfigurable to achieve different second beamforming component configuration states of the reconfigurable arrangement to convert the one or more intermediate beam patterns into the one or more output beam patterns based on the different second beamforming component configuration states. Each first beamforming component configuration state can correspond to a frequency-domain mode for the first beamforming component and each second beamforming component configuration state can correspond to a frequency-domain mode for the second beamforming component of one or more frequencies of the feed waves.

In various embodiments, a method for beamforming feed waves can include controlling a reconfigurable arrangement of a first beamforming component, a second beamforming component, and a third beamforming component. Specifically, the reconfigurable arrangement can be controlled to form one or more beam patterns from the feed waves based on one or more beamforming component configuration states of the reconfigurable arrangement. In controlling the reconfigurable arrangement to form the beam patterns, the first beamforming component can be controlled to convert the feed waves received at the first beamforming component from a feed source into one or more intermediate beam patterns. Further, in controlling the reconfigurable arrangement to form the beam patterns, the second beamforming component can be controlled to convert the one or more intermediate beams received at the second beamforming component from the first beamforming component into the one or more output beam patterns based on the reconfigurable arrangement. Additionally, in controlling the reconfigurable arrangement to form the beam patterns, the third beamforming component can be controlled to convert the one or more output beam patterns received at the third beamforming component from the second beamforming component into the one or more beam patterns based on the reconfigurable arrangement.

### BRIEF DESCRIPTION OF THE DRAWINGS

FIG. 1 illustrates an example system for beamforming feed waves.

FIG. 2 illustrates an example reconfigurable beamforming apparatus.

FIG. 3 illustrates another example reconfigurable beamforming apparatus.

FIG. 4 illustrates an example reconfigurable beamforming apparatus with three beamforming components.

FIG. 5 is a flowchart of an example method of controlling one or more beamforming components in a beamforming apparatus to convert feed waves into one or more output beam patterns.

FIGS. 6A-6D show a view of a beamforming component as the beamforming component is rotated.

FIGS. 7A-7D show the corresponding far field output beam pattern created using the beamforming component of FIGS. 6A-6D as it is rotated.

### DETAILED DESCRIPTION

The subject disclosure describes improved systems and methods for performing beamforming. Specifically, the subject disclosure describes improved beamforming systems and methods for meeting increasing operational limits required for current and new beamforming applications while still remaining feasible to implement from a cost perspective. Further, the subject disclosure described improved metamaterial-based beamforming systems and methods for meeting increasing operational limits required for current and new beamforming applications while still remaining feasible to implement from a cost perspective. Notably, the subject matter disclosed herein may be employed in a variety of applications such as wireless communications, heating, wireless power transmission, far field directed beams, 3D tomography, RADAR, and the like. While certain applications are discussed in greater detail herein, such discussion is for purposes of explanation, not limitation.

In various embodiments, the subject matter described herein can be implemented using metamaterials/metamaterial-based structures. Metamaterials generally feature subwavelength elements, i.e. structural elements with portions having electromagnetic length scales smaller than an operating wavelength of the metamaterial, and the subwavelength elements have a collective response to electromagnetic radiation that corresponds to an effective continuous medium response, characterized by an effective permittivity, an effective permeability, an effective magnetoelectric coefficient, or any combination thereof. For example, the electromagnetic radiation may induce charges and/or currents in the subwavelength elements, whereby the subwavelength elements acquire nonzero electric and/or magnetic dipole moments. Where the electric component of the electromagnetic radiation induces electric dipole moments, the metamaterial has an effective permittivity; where the magnetic component of the electromagnetic radiation induces magnetic dipole moments, the metamaterial has an effective permeability; and where the electric (magnetic) component induces magnetic (electric) dipole moments (as in a chiral metamaterial), the metamaterial has an effective magnetoelectric coefficient. Some metamaterials provide an artificial magnetic response; for example, split-ring resonators (SRRs)—or other LC or plasmonic resonators—built from nonmagnetic conductors can exhibit an effective magnetic permeability (c.f. J. B. Pendry et al, “Magnetism from conductors and enhanced nonlinear phenomena,” IEEE Trans. Micro. Theo. Tech. 47, 2075 (1999), herein incorporated by reference). Some metamaterials have “hybrid” electromagnetic properties that emerge partially from structural characteristics of the metamaterial, and partially from intrinsic properties of the constituent materials. For example, G. Dewar, “A thin wire array and magnetic host structure with n<0,” J. Appl. Phys. 97, 10Q101 (2005), herein incorporated by reference, describes a metamaterial consisting of a wire array (exhibiting a negative permeability as a consequence of its structure) embedded in a nonconducting ferrimagnetic host medium (exhibiting an intrinsic negative permeability). Metamaterials can be designed and fabricated to exhibit selected permittivities, permeabilities, and/or magnetoelectric coefficients that depend upon material properties of the constituent materials as well as shapes, chiralities, configurations, positions, orientations, and couplings between the subwavelength elements. The selected permittivites, permeabilities, and/or magnetoelectric coefficients can be positive or negative, complex (having loss or gain), anisotropic, variable in space (as in a gradient index lens), variable in time (e.g. in response to an external or feedback signal), variable in frequency (e.g. in the vicinity of a resonant frequency of the metamaterial), or any combination thereof. The selected electromagnetic properties can be provided at wavelengths that range from radio wavelengths to infrared/visible wavelengths; the latter wavelengths are attainable, e.g., with nanostructured materials such as nanorod pairs or nano-fishnet structures (c.f. S. Linden et al, “Photonic metamaterials: Magnetism at optical frequencies,” IEEE J. Select. Top. Quant. Elect. 12, 1097 (2006) and V. Shalaev, “Optical negative-index metamaterials,” Nature Photonics 1, 41 (2007), both herein incorporated by reference). An example of a three-dimensional metamaterial at optical frequencies, an elongated-split-ring “woodpile” structure, is described in M. S. Rill et al, “Photonic metamaterials by direct laser writing and silver chemical vapour deposition,” Nature Materials advance online publication, May 11, 2008, (doi:10.1038/nmat2197).

While many exemplary metamaterials are described as including discrete elements, some implementations of metamaterials may include non-discrete elements or structures. For example, a metamaterial may include elements comprised of sub-elements, where the sub-elements are discrete structures (such as split-ring resonators, etc.), or the metamaterial may include elements that are inclusions, exclusions, layers, or other variations along some continuous structure (e.g. etchings on a substrate). Some examples of layered metamaterials include: a structure consisting of alternating doped/intrinsic semiconductor layers (cf. A. J. Hoffman, “Negative refraction in semiconductor metamaterials,” Nature Materials 6, 946 (2007), herein incorporated by reference), and a structure consisting of alternating metal/dielectric layers (cf. A. Salandrino and N. Engheta, “Far-field subdiffraction optical microscopy using metamaterial crystals: Theory and simulations,” Phys. Rev. B 74, 075103 (2006); and Z. Jacob et al, “Optical hyperlens: Far-field imaging beyond the diffraction limit,” Opt. Exp. 14, 8247 (2006); each of which is herein incorporated by reference). The metamaterial may include extended structures having distributed electromagnetic responses (such as distributed inductive responses, distributed capacitive responses, and distributed inductive-capacitive responses). Examples include structures consisting of loaded and/or interconnected transmission lines (such as microstrips and striplines), artificial ground plane structures (such as artificial perfect magnetic conductor (PMC) surfaces and electromagnetic band gap (EGB) surfaces), and interconnected/extended nanostructures (nano-fishnets, elongated SRR woodpiles, etc.).

According to various embodiments, an apparatus for beamforming feed waves can include a reconfigurable arrangement of a first beamforming component and a second beamforming component. The first beamforming component can be configured to convert feed waves from a feed source into one or more intermediate beam patterns. The second beamforming component can be configured to convert the one or more intermediate beam patterns received at the second beamforming component from the first beamforming component into one or more output beam patterns based on one or more beamforming component configuration states of the reconfigurable arrangement.

In various embodiments, an apparatus for beamforming feed waves can include a reconfigurable arrangement of a first beamforming component and a second beamforming component. The first beamforming component can be configured to convert feed waves from a feed source into one or more intermediate beam patterns. The second beamforming component can be configured to convert the one or more intermediate beam patterns received at the second beamforming component from the first beamforming component into one or more output beam patterns based on one or more beamforming component configuration states of the reconfigurable arrangement. Specifically, the first beamforming component can be reconfigurable to achieve different first beamforming component configuration states of the reconfigurable arrangement to convert the feed waves into the one or more intermediate beam patterns based on the different first beamforming component configuration states. Further, the second beamforming component can be reconfigurable to achieve different second beamforming component configuration states of the reconfigurable arrangement to convert the one or more intermediate beam patterns into the one or more output beam patterns based on the different second beamforming component configuration states. Each first beamforming component configuration state can correspond to a frequency-domain mode for the first beamforming component and each second beamforming component configuration state can correspond to a frequency-domain mode for the second beamforming component of one or more frequencies of the feed waves.

In certain embodiments, an apparatus for beamforming feed waves can include a reconfigurable arrangement of a first beamforming component, a second beamforming component and a third beamforming component. The first beamforming component can be configured to convert feed waves from a feed source into one or more intermediate beam patterns. The second beamforming component can be configured to convert the one or more intermediate beam patterns received at the second beamforming component from the first beamforming component into one or more output beam patterns based on one or more beamforming component configuration states of the reconfigurable arrangement. Further, the third beamforming component can be configured to convert the one or more output beam patterns received at the third beamforming component from the second beamforming component into one or more beam patterns based on different third beamforming component configuration states of the third beamforming component as part of the one or more beamforming component configuration states of the reconfigurable arrangement.

In various embodiments, a method for beamforming feed waves can include controlling a reconfigurable arrangement of a first beamforming component and a second beamforming component. Specifically, the reconfigurable arrangement can be controlled to form one or more output beam patterns from the feed waves based on one or more beamforming component configuration states of the reconfigurable arrangement. In controlling the reconfigurable arrangement to form the output beam patterns, the first beamforming component can be controlled to convert the feed waves received at the first beamforming component from a feed source into one or more intermediate beam patterns. Further, in controlling the reconfigurable arrangement to form the output beam patterns, the second beamforming component can be controlled to convert the one or more intermediate beams received at the second beamforming component from the first beamforming component into the one or more output beam patterns based on the reconfigurable arrangement.

In certain embodiments, a method for beamforming feed waves can include controlling a reconfigurable arrangement of a first beamforming component and a second beamforming component. Specifically, the reconfigurable arrangement can be controlled to form one or more output beam patterns from the feed waves based on one or more beamforming component configuration states of the reconfigurable arrangement. In controlling the reconfigurable arrangement to form the output beam patterns, the first beamforming component can be controlled to convert the feed waves received at the first beamforming component from a feed source into one or more intermediate beam patterns. Further, in controlling the reconfigurable arrangement to form the output beam patterns, the second beamforming component can be controlled to convert the one or more intermediate beam patterns received at the second beamforming component from the first beamforming component into the one or more output beam patterns based on the reconfigurable arrangement. Specifically, the first beamforming component can be reconfigurable to achieve different first beamforming component configuration states of the reconfigurable arrangement to convert the feed waves into the one or more intermediate beam patterns based on the different first beamforming component configuration states. Further, the second beamforming component can be reconfigurable to achieve different second beamforming component configuration states of the reconfigurable arrangement to convert the one or more intermediate beam patterns into the one or more output beam patterns based on the different second beamforming component configuration states. Each first beamforming component configuration state can correspond to a frequency-domain mode for the first beamforming component and each second beamforming component configuration state can correspond to a frequency-domain mode for the second beamforming component of one or more frequencies of the feed waves.

In various embodiments, a method for beamforming feed waves can include controlling a reconfigurable arrangement of a first beamforming component, a second beamforming component, and a third beamforming component. Specifically, the reconfigurable arrangement can be controlled to form one or more beam patterns from the feed waves based on one or more beamforming component configuration states of the reconfigurable arrangement. In controlling the reconfigurable arrangement to form the beam patterns, the first beamforming component can be controlled to convert the feed waves received at the first beamforming component from a feed source into one or more intermediate beam patterns. Further, in controlling the reconfigurable arrangement to form the beam patterns, the second beamforming component can be controlled to convert the one or more intermediate beam patterns received at the second beamforming component from the first beamforming component into the one or more output beam patterns based on the reconfigurable arrangement. Additionally, in controlling the reconfigurable arrangement to form the beam patterns, the third beamforming component can be controlled to convert the one or more output beam patterns received at the third beamforming component from the second beamforming component into the one or more beam patterns based on the reconfigurable arrangement.

Some of the infrastructure that can be used with embodiments disclosed herein is already available, such as general-purpose computers, RF antennas, computer programming tools and techniques, digital storage media, and communications networks. A computing device may include a processor such as a microprocessor, microcontroller, logic circuitry, or the like. The processor may include a special purpose processing device such as an ASIC, PAL, PLA, PLD, FPGA, or other customized or programmable device. The computing device may also include a computer-readable storage device such as non-volatile memory, static RAM, dynamic RAM, ROM, CD-ROM, disk, tape, magnetic, optical, flash memory, or other computer-readable storage medium.

Various aspects of certain embodiments may be implemented using hardware, software, firmware, or a combination thereof. As used herein, a software module or component may include any type of computer instruction or computer executable code located within or on a computer-readable storage medium. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media. Some embodiments may be practiced in a distributed computing environment where tasks are performed by a remote processing device linked through a communications network.

The embodiments of the disclosure will be best understood by reference to the drawings, wherein like parts are designated by like numerals throughout. The components of the disclosed embodiments, as generally described and illustrated in the figures herein, could be arranged and designed in a wide variety of different configurations. Furthermore, the features, structures, and operations associated with one embodiment may be applicable to or combined with the features, structures, or operations described in conjunction with another embodiment. In other instances, well-known structures, materials, or operations are not shown or described in detail to avoid obscuring aspects of this disclosure.

Thus, the following detailed description of the embodiments of the systems and methods of the disclosure is not intended to limit the scope of the disclosure, as claimed, but is merely representative of possible embodiments. In addition, the steps of a method do not necessarily need to be executed in any specific order, or even sequentially, nor need the steps be executed only once.

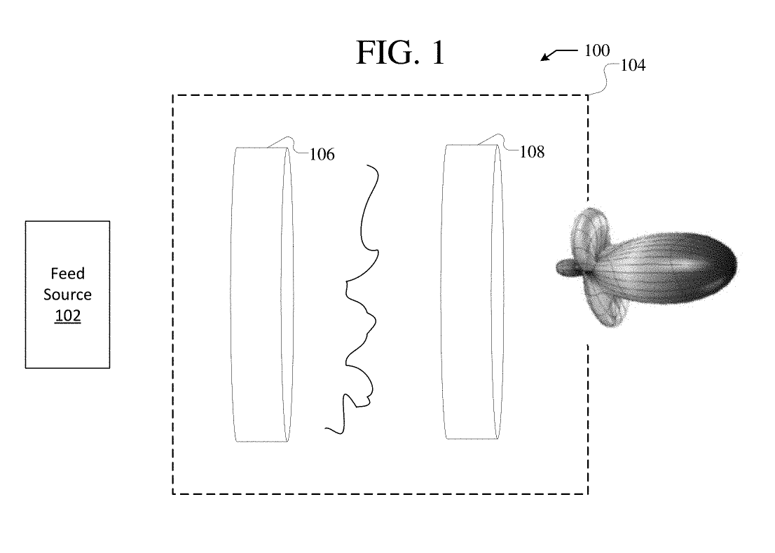

FIG. 1 illustrates an example system 100 for beamforming feed waves. The example system 100 shown in FIG. 1 includes a feed source 102 and a beamforming apparatus 104. The feed source 102 functions according to an applicable feed for providing feed waves to the beamforming apparatus 104. The beamforming apparatus 104 can subsequently generate one or more beam patterns, e.g. output beam patterns, from the feed waves as part of beamforming the feed waves.

The feed source 102 can emit feed waves at one or more applicable frequencies. Specifically, the feed source 102 can emit electromagnetic feed waves. For example, the feed source 102 can emit feed waves having operational frequencies in the radio frequency band, the microwave band, the millimeter band, and/or the terahertz band. In another example, the feed source 102 can emit feed waves having operational frequencies in the infrared spectrum and/or the optical spectrum. Additionally, the feed source 102 can emit acoustic feed waves. For example, the feed source 102 can emit feed waves having operational frequencies in the audible acoustic band (16 Hz-20 kHz), operational frequencies in the ultrasound acoustic band (20 kHz-100 MHz), and/or operational frequencies in the hypersound acoustic band (100 MHz-100 GHz).

The feed source 102 can be an applicable apparatus or system for emitting feed waves for beamforming. Further the feed source 102 can include applicable components for emitting feed waves for beamforming. The feed source 102 can include one antenna or an array of antennas for emitting feed waves. For example, the feed source 102 can include an array of antennas for emitting electromagnetic feed waves. Further, the feed source 102 can include one or more amplifiers configured to amplify one or more feed signals of feed waves emitted by the feed source 102. For example, when the feed source 102 includes an array of antennas, the feed source 102 can include a plurality of amplifiers corresponding to each antenna in the array. Further in the example, each amplifier can amplify a feed signal of a corresponding antenna in the array of antennas. In another example, the feed source 102 can include a single antenna and an amplifier corresponding to the single antenna. Further in the example, the amplifier can amplify a feed signal for the single antenna.

The feed source 102 can include one or a plurality of components for generating optical feed waves, e.g. feed waves in the infrared spectrum or the optical spectrum. For example, the feed source 102 can include one or more light emitting diodes (“LEDs”) for generating optical feed waves, e.g. based on feed signals. Further, the feed source 102 can include one or a plurality of components for generating acoustic feed waves. For example, the feed source 102 can include one or more stimulated vibration-elements for generating acoustic feed waves, e.g. based on feed signals. For example, the feed source 102 can include one or more piezoelectric elements for generating acoustic feed waves based on feed signals.

Further, the feed source 102 can include a semi-open cavity. For example, the feed source 102 can include a semi-open cavity for resonating acoustic feed waves from the feed source 102. A semi-open cavity of the feed source 102 can include a single feed port that is used to emit feed waves from the feed source 102. For example, a single feed port of a semi-open cavity of the feed source 102 can serve as a waveguide port for transmitting feed waves from the feed source 102. Alternatively, a semi-open cavity of the feed source 102 can include a plurality of feed ports that are used to emit feed waves from the feed source 102. A feed port of a semi-open cavity of the feed source 102 can be a coaxial port. Further, a feed port of a semi-open cavity of the feed source 102 can be a lumped port. One or more feed ports included as part of a semi-open cavity of the feed source 102 can be positioned at a bottom center or near the bottom center of a semi-open cavity of the feed source 102. In turn, this can ensure that the semi-open cavity properly emits feed waves using feed signals received at the one or more feed ports. For example, the one or more feed ports can be positioned within a certain distance of the bottom center of the semi-open cavity of the feed source 102 to ensure that the semi-open cavity properly emits the feed waves using the feed signals received at the one or more feed ports.

The beamforming apparatus 104 includes a first beamforming component 106 and a second beamforming component 108. The first beamforming component 106 functions to receive feed waves from the feed source 102. Further the first beamforming component 106 can convert feed waves received from the feed source 102 into one or more intermediate beam patterns, e.g. as part of beamforming feed waves emitted by the feed source 102. The second beamforming component 108 functions to receive one or more intermediate beam patterns from the first beamforming component 106. Specifically, the second beamforming component 108 can receive one or more intermediate beam patterns generated by the first beamforming component 106 from feed waves emitted by the feed source 102. The second beamforming component 108 can convert intermediate beam patterns generated by the first beamforming component 106 into one or more output beam patterns, e.g. as part of beamforming feed waves emitted by the feed source 102. Specifically, the second beamforming component 108 can convert intermediate beam patterns generated by the first beamforming component 106 into a discrete output beam pattern or a set of continuous output beam patterns.

The first beamforming component 106 can create one or more intermediate beam patterns within a radiative near field of the first beamforming component 106. Specifically the second beamforming component 108 can be within the radiative near field of the first beamforming component 106. Subsequently, one or more intermediate beam patterns created by the first beamforming component 106 and received at the second beamforming component 108 can be within the radiative near field of the first beamforming component 106. One or more intermediate beam patterns created by the first beamforming component 106 can produce a 3D field distribution such that different 2D slices of the one or more beam patterns can act as different beams when incident upon the second beamforming component 108.

The first beamforming component 106 and the second beamforming component 108 can each have separate beamforming component configuration states. A beamforming component configuration state, as will be discussed in greater detail later with respect to reconfigurable beamforming components, can include an orientation, e.g. mechanical orientation, of a beamforming component. Further, a beamforming component configuration state, as will be discussed in greater detail later, can include electrical characteristics of a beamforming component, e.g. adjustable electrical characteristics of elements of the beamforming component. For example, a beamforming component configuration state of the first beamforming component 106 can include an orientation of the first beamforming component 106 with respect to the feed source 102. In another example, a beamforming component configuration state of the second beamforming component 108 can include electrical characteristics of metamaterial elements in the second beamforming component 108.

Corresponding beamforming component configuration states of the first beamforming component 106 and the second beamforming component 108 can form a reconfigurable arrangement of the beamforming apparatus 104. A reconfigurable arrangement of the beamforming apparatus 104 can be defined based on beamforming component configuration states of the first beamforming component 106 and the second beamforming component. For example, a reconfigurable arrangement of the beamforming apparatus 104 can be defined according to a specific orientation of the first beamforming component 106 and electrical characteristics of the second beamforming component 106.

A reconfigurable arrangement of the beamforming apparatus 104 can be reconfigurable according to variable beamforming component configuration states of either or both the first beamforming component 106 and the second beamforming component 108. Specifically, either or both the first beamforming component 106 and the second beamforming component 108 can be reconfigured, e.g. controlled, to change corresponding beamforming component configuration states of either or both the first beamforming component 106 and the second beamforming component 108. In turn, this can change the arrangement of the beamforming apparatus 104 to create a reconfigurable arrangement based on the adjustable beamforming component configuration states of either or both the first beamforming component 106 and the second beamforming component 108. For example, an orientation of the second beamforming component 108 can be changed to ultimately select or achieve an arrangement of the reconfigurable arrangement of the beamforming apparatus 104.

In various embodiments, the first beamforming component 106 remains in a static beamforming component configuration state while the second beamforming component 108 is reconfigured to change the reconfigurable arrangement of the beamforming apparatus 104. Specifically, the second beamforming component 108 can be controlled to change its beamforming component configuration state while the first beamforming component 106 is kept in the same beamforming component configuration state, e.g. as part of controlling the first beamforming component 106. Alternatively, the second beamforming component 108 can remain in a static beamforming component configuration state while the first beamforming component 106 is reconfigured to change the reconfigurable arrangement of the beamforming apparatus 104. Specifically, the first beamforming component 106 can be controlled to change its beamforming component configuration state while the second beamforming component 108 is kept in the same beamforming component configuration state, e.g. as part of controlling the second beamforming component 108.

A static beamforming component configuration state, as used herein, is a beamforming component configuration state that does not change during operation of the beamforming apparatus 104. For example the first beamforming component 106 can be kept in a static beamforming component configuration state by not changing either or both an orientation and electrical characteristics of the first beamforming component 106. In various embodiments, one of the first and second beamforming components 106 and 108 are not reconfigurable and therefore always remain in the same static beamforming component configuration state. Alternatively, one of the first and second beamforming components 106 and 108 can be reconfigurable but are controlled to remain unchanged in the same static beamforming component configuration state.

The second beamforming component 108 is configured to generate one or more output beam patterns based on a reconfigurable arrangement of the beamforming apparatus 104. Specifically, the second beamforming component 108 can generate one or more output beam patterns based on beamforming component configuration states of the first beamforming component 106 and the second beamforming component 108 that form the reconfigurable arrangement of the beamforming apparatus 104. More specifically, the second beamforming component 108 can generate output beam patterns based on an orientation and/or electrical characteristics of the first beamforming component 106 that define a beamforming component configuration state of the first beamforming component 106. For example, the first beamforming component 106 can generate intermediate beam patterns based on the orientation and/or electrical characteristics of the first beamforming component 106. Subsequently, the second beamforming component 108 can generate output beam patterns based, at least in part, on the intermediate patterns created by the first beamforming component 106 based on the orientation and/or electrical characteristics of the first beamforming component 106. In another example, the second beamforming component 108 can generate output beam patterns based on an orientation and/or electrical characteristics of the second beamforming component 108 that define a beamforming component configuration state of the second beamforming component 108.

In generating output beam patterns based on a reconfigurable arrangement of the beamforming apparatus 104, the second beamforming component 108 can generate the output beam patterns based on an adjustable/reconfigurable beamforming component state of either or both the first beamforming component 106 and the second beamforming component 108. For example, the first beamforming component 106 can be a reconfigurable beamforming component and the second beamforming component 108 can generate an output beam pattern based on a first beamforming component configuration state achieved by adjusting the reconfigurable first beamforming component 106. In another example, the second beamforming component 108 can be a reconfigurable beamforming component and the second beamforming component 108 can generate an output beam pattern based on a second beamforming component configuration state achieved by adjusting the reconfigurable second beamforming component 108. In yet another example, both the first beamforming component 106 and the second beamforming component 108 can be reconfigurable beamforming components and the second beamforming component 108 can generate an output beam pattern based on a first beamforming component configuration state achieved by adjusting the reconfigurable first beamforming component 106 and a second beamforming component configuration state achieved by adjusting the reconfigurable second beamforming component 108.

The second beamforming component 108 can create one or more output beam patterns based on a static beam configuration state of either or both the first beamforming component 106 and the second beamforming component 108. For example, electrical characteristics of the first beamforming component 106 can remain unchanged while a beamforming component configuration state of the second beamforming component 108 is changed to cause the second beamforming component 108 to create a specific output beam pattern. In another example, a position of the second beamforming component 108 can remain unchanged while a beamforming component configuration state of the first beamforming component 106 is changed to cause the second beamforming component 108 to create a specific output beam pattern.

Either or both the first beamforming component 106 and the second beamforming component 108 can be controlled, e.g. to achieve a specific arrangement of a reconfigurable arrangement of beamforming component configuration states, to form specific output beam patterns. Specifically, the first and second beamforming components 106 and 108 can be controlled to form a specific far-field beam pattern in one or more output beam patterns generated by the second beamforming component 108. For example, the first and second beamforming components 106 and 108 can be controlled to form a pencil beam in a far-field beam pattern. In another example, the first and second beamforming components 106 and 108 can be controlled to form a fan beam in a far-field beam pattern. Further, the first and second beamforming components 106 and 108 can be controlled to form a specific near-field beam pattern in one or more output beam patterns generated by the second beamforming component 108. For example, the first and second beamforming components 106 and 108 can be controlled to form a focused beam pattern in a near-field beam pattern. While the output beam pattern shown in FIG. 1 is a pencil beam pattern, this is shown for illustrative purposes only, and the first and second beamforming components 106 and 108 can be controlled to form an applicable output beam pattern, such as the previously described output beam patterns.

Further, either or both the first beamforming component 106 and the second beamforming component 108 can be controlled to ultimately control a main lobe in an output beam pattern generated by the second beamforming component 108. Specifically, the first and second beamforming components 106 and 108 can be controlled to select an angle of a direction of a main lobe in an output beam pattern generated by the second beamforming component 108. Additionally, the first and second beamforming components 106 and 108 can be controlled to select a direction of a main lobe in an output beam pattern generated by the second beamforming component 108.

Additionally, either or both the first beamforming component 106 and the second beamforming component 108 can be controlled to ultimately control a focal point in an output beam pattern generated by the second beamforming component 108. Specifically, the first and second beamforming components 106 and 108 can be controlled to select a direction towards a focal point in an output beam pattern generated by the second beamforming component 108. Additionally, the first and second beamforming components 106 and 108 can be controlled to select a distance to a focal point, e.g. a focal length, in an output beam pattern generated by the second beamforming component 108.

Either or both the first beamforming component 106 and the second beamforming component 108 can be controlled to ultimately control a focused beam formed by one or more output beam patterns generated by the second beamforming component 108. Specifically, the first and second beamforming components 106 and 108 can be controlled to select a depth of focus of a focused beam in one or more output beam patterns generated by the second beamforming component 108.

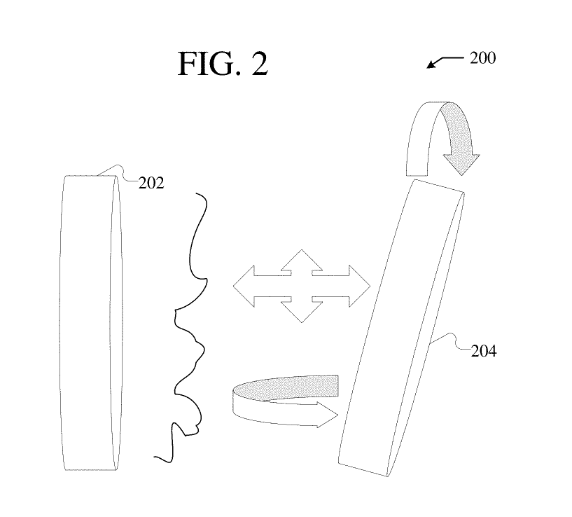

FIG. 2 illustrates an example reconfigurable beamforming apparatus 200. The reconfigurable beamforming apparatus 200 functions according to an applicable apparatus for beamforming feed waves, such as the beamforming apparatuses described herein. The reconfigurable beamforming apparatus 200 includes a first beamforming component 202 and a second beamforming component 204. The first beamforming component 202 and the second beamforming component 204 function according to applicable beamforming components, such as the corresponding first and second beamforming components described herein. Specifically, the first beamforming component 202 can convert feed waves received at the first beamforming component 202 into one or more intermediate beam patterns, as part of beamforming the feed waves. Further, the second beamforming component 204 can convert the one or more intermediate beam patterns into one or more output beam patterns, as part of beamforming the feed waves.

In being reconfigurable, the beamforming apparatus 200 can include a reconfigurable arrangement of the first beamforming component 202 and the second beamforming component 204. Specifically, the second beamforming component 204 is reconfigurable to achieve different beamforming component configuration states as part of the reconfigurable arrangement of the beamforming apparatus 200. In turn, the second beamforming component 204 can generate a specific output beam pattern based on a changed beamforming component configuration state of the second beamforming component 204, as part of the reconfigurable arrangement of the beamforming apparatus 200. For example, as will be described in greater detail later, the second beamforming component 204 can rotate in order to convert intermediate beam patterns received from the first beamforming component 202 into specific/desired output beam patterns. While the example beamforming apparatus 200 shown in FIG. 2 is only shown with a reconfigurable second beamforming component 204, in various embodiments, the first beamforming component 202 can be a reconfigurable beamforming component as well. Specifically, both the first and second beamforming components 202 and 204 can be controlled to change corresponding beamforming component configuration states of the first and second beamforming components 202 and 204 to create a specific output beam pattern.

Different beamforming component configuration states achievable by the second beamforming component 204, e.g. through reconfiguration of the second beamforming component 204, can be pre-defined beamforming component configuration states. For example, the different beamforming component configuration states can be pre-defined impedances of adjustable elements of the second beamforming component 204. Pre-defined beamforming component configuration states of the second beamforming component 204 can be pre-defined based on either or both specific intermediate beam patterns capable of being received at the second beamforming component 204 and specific output beam patterns capable of being generated by the second beamforming component 204. For example, a pre-defined beamforming component configuration state of the second beamforming component 204 can be defined to create a specific pencil beam in a far-field pattern from intermediate beam patterns received at the second beamforming component 204.

Pre-defined beamforming component configuration states of the second beamforming component 204 can correspond to different wave holograms, e.g. each pre-defined beamforming component configuration state can correspond to a specific wave hologram. The wave holograms for the pre-defined beamforming component configuration states can be physically embedded in the second beamforming component 204. Further, the second beamforming component 204 can be reconfigured according to the wave holograms physically embedded in the second beamforming component 204 to select a specific output beam pattern. In particular, a specific wave hologram physically embedded in the second beamforming component 204 can be excited in order to select a specific output beam pattern corresponding to the specific wave hologram. Additionally, one or more intermediate beam patterns received at the second beamforming component 204 can serve as one or more reconstruction beams for a specific wave hologram embedded in the second beamforming component 204, e.g. by exciting the specific wave hologram embedded in the second beamforming component 204.

The first beamforming component 202 can be reconfigured to achieve different beamforming component configuration states according to pre-defined beamforming component configuration states of the second beamforming component 204. Specifically, the first beamforming component 202 can be reconfigured according to specific wave holograms of corresponding pre-defined beamforming component configuration states of the second beamforming component 204 to select a specific output beam pattern. More specifically, the first beamforming component 202 can be reconfigured to excite a specific wave hologram of the second beamforming component 204 that corresponds to the specific output beam pattern in order to create the specific output beam pattern using the specific wave hologram. For example, the first beamforming component 202 can be reconfigured to create one or more specific intermediate beam patterns of variable intermediate beam patterns that excite a specific wave hologram of the second beamforming component corresponding to a specific output beam pattern. In turn, the specific output beam pattern can be created by the second beamforming component 204 through the specific wave hologram using the specific intermediate beam patterns received at the second beamforming component 204.

The second beamforming component 204 can remain in a static beamforming component configuration state while specific intermediate beam patterns of the first beamforming component 202 are selected to retrieve specific wave holograms. Specifically, one or more specific intermediate beam patterns can be selected to excite a specific wave hologram of the second beamforming component 204 while the second beamforming component 204 remains in a static beamforming component configuration state in order to generate one or more selected output beam patterns. For example, the first beamforming component 202 can be reconfigured to create a specific intermediate beam pattern of variable intermediate beam patterns. Further in the example, the specific intermediate beam pattern and a corresponding configuration of the first beamforming component 202 can be selected based on a corresponding wave hologram at the second beamforming component 204 for generating the selected output beam pattern. In turn, the specific intermediate pattern can be generated at the first beamforming component 202 to cause the second beamforming component 204 to generate the specific output beam pattern from the intermediate beam pattern using the corresponding wave hologram, while the second beamforming component 204 remains in a static configuration.

Either or both the first beamforming component 202 and the second beamforming component 204 can include one or a combination of a distribution of scattering elements, diffractive elements, and reflective elements. Specifically, either or both the first beamforming component 202 and the second beamforming component 204 can include a distribution of metamaterial elements that act as scattering elements, diffractive elements, and/or reflective elements. While a distribution of scattering elements, diffractive elements, and reflective elements is discussed with respect to the first beamforming component 202 and the second beamforming component 204 shown in FIG. 2, in various embodiments, an applicable beamforming component, such as the beamforming components described herein can include one or a combination of a distribution of scattering elements, diffractive elements, and reflective elements.

Further, either or both the first beamforming component 202 and the second beamforming component 204 can include a distribution of refractive elements, e.g. metamaterial elements acting as refractive elements. At least one of the refractive elements can be comprised of an effective medium having a specific index of refraction defined relative to an ambient medium. Specifically, the refractive elements can have a specific index of refraction with respect to an ambient medium in the range of 1-10 or 10-100. Further, the refractive elements can have a specific index of refraction with respect to an ambient medium in the range of 0.1-1, 0.01-0.1, or 0.01-100. Additionally, the refractive elements can have a specific index of refraction with respect to an ambient medium that has low dispersion in the frequency band, and the dispersion in in the range of 0-0.1 per octave, e.g. for acoustic feed waves processed by the beamforming apparatus 200.

Further, an effective medium of a refractive element can be impedance-matched to a homogenous medium adjacent to either or both the first beamforming component 202 and the second beamforming component 204. For example, a refractive element of the second beamforming component can be impedance-matched to a homogenous medium adjacent to the first beamforming component 202. A homogenous medium adjacent to the first beamforming component 202 and the second beamforming component 204 can depend on an application of the beamforming apparatus 200. For example, if the beamforming apparatus 200 is operated in water, then a homogenous medium can include water. While a distribution of refractive elements is discussed with respect to the first beamforming component 202 and the second beamforming component 204 shown in FIG. 2, an applicable beamforming component, such as the beamforming components described herein, can include a distribution of refractive elements having the previously described characteristics.

An ambient medium, as used herein, can include a medium surrounding one or more applicable beamforming components, e.g. either or both the first beamforming component 202 and the second beamforming component 204. For example, an ambient medium can include a medium between the first beamforming component 202 and the second beamforming component 204. An ambient medium can be comprised of one or a combination of an applicable liquid, gas, or solid. For example, an ambient medium can include a fluid disposed between the first beamforming component 202 and the second beamforming component 204. Further in the example, the fluid disposed between the first beamforming component 202 and the second beamforming component 204 can include an oil or water. In another example, an ambient medium can include air or nitrogen gas.

The second beamforming component 204 can be mechanically reconfigurable to achieve different beamforming component configuration states. Specifically, the second beamforming component 204 can be electromechanically reconfigurable to mechanically reconfigure the second beamforming component 204. For example, an electric field can be applied to the second beamforming component 204 to mechanically reconfigure the second beamforming component 204. Additionally, the second beamforming component 204 can include one or more mechanically configurable elements for mechanically reconfiguring the second beamforming component 204 to achieve different beamforming component configuration states. For example, the second beamforming component 204 can include one or more motors to displace the second beamforming component 204. The one or more mechanically configurable elements can have adjustable complex impedances, e.g. electric or acoustic impedances, which are varied for mechanically reconfiguring the second beamforming component 204. For example, a complex impedance of a mechanically configurable element of the second beamforming component 204 can be adjusted to cause the second beamforming component 204 to rotate about an axis.

An orientation of the second beamforming component 204 within the beamforming apparatus 200 can be changed in order to mechanically reconfigure the second beamforming component 204. Specifically, an orientation of the second beamforming component 204 with respect to the first beamforming component 202 can be changed to mechanically reconfigure the second beamforming component 204 to achieve different beamforming component configuration states. An orientation of the second beamforming component 204 with respect to the first beamforming component 202 can be changed by either or both rotating the second beamforming component 204 and displacing the second beamforming component 204. For example, the second beamforming component 204 can be displaced closer to the first beamforming component 202 in order to change an orientation of the second beamforming component 204, e.g. as part of mechanically reconfiguring the second beamforming component 204.

An orientation of the second beamforming component 204 within the beamforming apparatus 200 can be changed using an applicable displacement or rotation mechanism. Specifically, an orientation of the second beamforming component 204 with respect to the first beamforming component 202 can be changed using an applicable rotation or displacement mechanism. For example, an orientation of the second beamforming component 204 can be changed based on electromechanically reconfigurable characteristics of the second beamforming component 204 and/or mechanically configurable elements of the second beamforming component 204.

The second beamforming component 204 can be electrically reconfigurable to achieve different beamforming component configuration states. Specifically, the second beamforming component 204 can include one or more electrically configurable elements for electrically reconfiguring the second beamforming component 204 to achieve different beamforming component configuration states. More specifically, electrically configurable elements can include metamaterial elements that can be electrically manipulated to reconfigure the second beamforming component 204. For example, voltages can be applied to metamaterial elements of the second beamforming component 204 to change electrical characteristics of the elements. Further in the example, this can change overall electrical characteristics of the second beamforming component 204, e.g. as part of electrically reconfiguring the second beamforming component 204.

Further, complex impedances of electrically configurable elements of the second beamforming component 204 can be adjusted in order to electrically reconfigure the second beamforming component 204. For example, acoustic impedances of the electrically configurable elements of the second beamforming component 204 can be adjusted as part of electrically reconfiguring the second beamforming component 204 to process acoustic waves and beam patterns. In another example, electric impedances of the electrically configurable elements of the second beamforming component 204 can be adjusted as part of electrically reconfiguring the second beamforming component 204 to process electromagnetic waves and beam patterns.

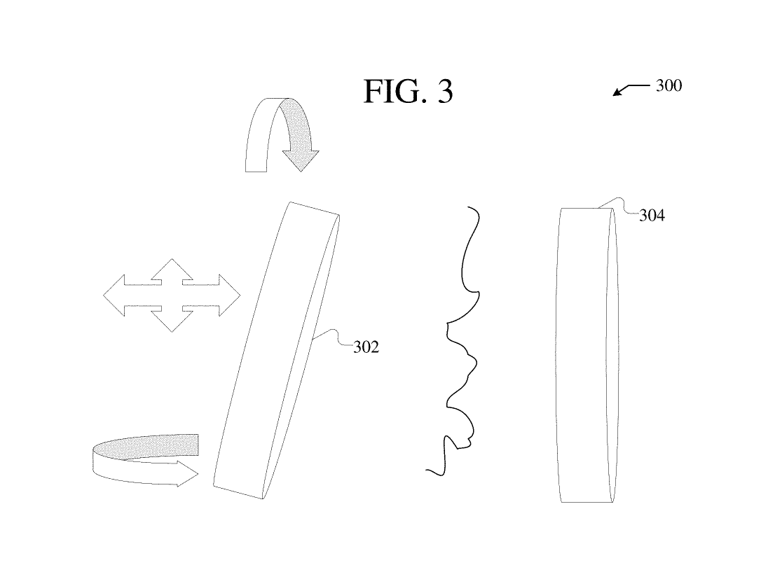

FIG. 3 illustrates another example reconfigurable beamforming apparatus 300. The reconfigurable beamforming apparatus 300 functions according to an applicable apparatus for beamforming feed waves, such as the beamforming apparatuses described herein. The reconfigurable beamforming apparatus 300 includes a first beamforming component 302 and a second beamforming component 304. The first beamforming component 302 and the second beamforming component 304 function according to applicable beamforming components, such as the corresponding first and second beamforming components described herein. Specifically, the first beamforming component 302 can convert feed waves received at the first beamforming component 302, e.g. from an applicable feed source such as the feed sources described herein, into one or more intermediate beam patterns, as part of beamforming the feed waves. Further, the second beamforming component 304 can convert the one or more intermediate beam patterns into one or more output beam patterns, as part of beamforming the feed waves.

In being reconfigurable, the beamforming apparatus 300 can include a reconfigurable arrangement of the first beamforming component 302 and the second beamforming component 304. Specifically, the first beamforming component 302 is reconfigurable to achieve different beamforming component configuration states as part of the reconfigurable arrangement of the beamforming apparatus 300. In turn, the first beamforming component 302 can generate a specific intermediate beam pattern based on a changed beamforming component configuration state of the first beamforming component 302, as part of the reconfigurable arrangement of the beamforming apparatus 300. For example, as will be described in greater detail later, electrical characteristics of the first beamforming component 302 can be changed in order to convert feed waves received from a feed source into specific/desired intermediate beam patterns. While the example beamforming apparatus 300 shown in FIG. 3 is only shown with a reconfigurable first beamforming component 302, in various embodiments, the second beamforming component 304 can be a reconfigurable beamforming component as well. Specifically, both the first and second beamforming components 302 and 304 can be controlled to change corresponding beamforming component configuration states of the first and second beamforming components 302 and 304 to create a specific output beam pattern.

Different beamforming component configuration states achievable by the first beamforming component 302, e.g. through reconfiguration of the first beamforming component 302, can be pre-defined beamforming component configuration states. For example, the different beamforming component configuration states can be pre-defined orientations of the first beamforming component 302. Pre-defined beamforming component configuration states of the first beamforming component 302 can be pre-defined based on specific feed waves capable of being received at the first beamforming component 302. Further, pre-defined beamforming component configuration states of the first beamforming component 302 can be pre-defined based on specific intermediate beam patterns capable of being generated by the first beamforming component 302. For example, a pre-defined beamforming component configuration state of the first beamforming component 302 can be defined to create a specific intermediate beam pattern based on characteristics of feed waves received at the first beamforming component 302.

Pre-defined beamforming component configuration states of the first beamforming component 302 can correspond to different wave holograms, e.g. each pre-defined beamforming component configuration state can correspond to a specific wave hologram. The wave holograms for the pre-defined beamforming component configuration states can be physically embedded in the first beamforming component 302. Further, the first beamforming component 302 can be reconfigured according to the wave holograms physically embedded in the first beamforming component 302 to select a specific intermediate beam pattern. In particular, a specific wave hologram physically embedded in the first beamforming component 302 can be excited in order to select a specific intermediate beam pattern corresponding to the specific wave hologram.

Additionally, one or more intermediate beam patterns created by the first beamforming component 302 can serve as one or more reconstruction beams for a specific wave hologram embedded in the second beamforming component 304. Specifically, an intermediate beam pattern of the first beamforming component 302 can be selected to excite a specific wave hologram embedded in the second beamforming component 304. In turn, a specific output beam pattern corresponding to the specific wave hologram can effectively be selected based on selection of the intermediate beam pattern of the first beamforming component 302 to excite the specific wave hologram of the second beamforming component 304.

The second beamforming component 304 can be reconfigured to achieve different beamforming component configuration states according to pre-defined beamforming component configuration states of the first beamforming component 302. Specifically, the second beamforming component 304 can be reconfigured according to specific wave holograms of corresponding pre-defined beamforming component configuration states of the first beamforming component 302 to select a specific output beam pattern. More specifically, the second beamforming component 304 can be reconfigured based on an excited wave hologram of the first beamforming component 302 that corresponds to a specific intermediate beam pattern in order to create the specific output beam pattern based on the specific wave hologram. While still being reconfigurable, the first beamforming component 302 can remain in a static beamforming component configuration state while the second beamforming component 304 is reconfigured to create a selected output beam pattern.

The first beamforming component 302 can be mechanically reconfigurable to achieve different beamforming component configuration states. Specifically, the first beamforming component 302 can be electromechanically reconfigurable to mechanically reconfigure the first beamforming component 302. For example, an electric field can be applied to the first beamforming component 302 to mechanically reconfigure the first beamforming component 302. Additionally, the first beamforming component 302 can include one or more mechanically configurable elements for mechanically reconfiguring the first beamforming component 302 to achieve different beamforming component configuration states. For example, the first beamforming component 302 can include one or more motors to rotate the first beamforming component 302. The one or more mechanically configurable elements can have adjustable complex impedances, e.g. electric or acoustic impedances, which are varied for mechanically reconfiguring the first beamforming component 302. For example, a complex impedance of a mechanically configurable element of the first beamforming component 302 can be adjusted to cause the first beamforming component 302 to displace along an axis.

An orientation of the first beamforming component 302 within the beamforming apparatus 300 can be changed in order to mechanically reconfigure the first beamforming component 302. Specifically, an orientation of the first beamforming component 302 with respect to a feed source can be changed to mechanically reconfigure the first beamforming component 302 to achieve different beamforming component configuration states. An orientation of the first beamforming component 302 with respect to a feed source can be changed by either or both rotating the first beamforming component 302 and displacing the first beamforming component 302. For example, the first beamforming component 302 can be displaced closer to a feed source in order to change an orientation of the first beamforming component 302, e.g. as part of mechanically reconfiguring the first beamforming component 302.

An orientation of the first beamforming component 302 within the beamforming apparatus 300 can be changed using an applicable displacement or rotation mechanism. Specifically, an orientation of the first beamforming component 302 with respect to a feed source can be changed using an applicable rotation or displacement mechanism. For example, an orientation of the first beamforming component 302 can be changed based on electromechanically reconfigurable characteristics of the first beamforming component 302 and/or mechanically configurable elements of the first beamforming component 302.

The first beamforming component 302 can be electrically reconfigurable to achieve different beamforming component configuration states. Specifically, the first beamforming component 302 can include one or more electrically configurable elements for electrically reconfiguring the first beamforming component 302 to achieve different beamforming component configuration states. More specifically, electrically configurable elements can include metamaterial elements that can be electrically manipulated to reconfigure the first beamforming component 302. For example, voltages can be applied to metamaterial elements of the first beamforming component 302 to change electrical characteristics of the elements. Further in the example, this can change overall electrical characteristics of the first beamforming component 302, e.g. as part of electrically reconfiguring the first beamforming component 302.

Further, complex impedances of electrically configurable elements of the first beamforming component 302 can be adjusted in order to electrically reconfigure the first beamforming component 302. For example, acoustic impedances of the electrically configurable elements of the first beamforming component 302 can be adjusted as part of electrically reconfiguring the first beamforming component 302 to process acoustic waves and beam patterns. In another example, electric impedances of the electrically configurable elements of the first beamforming component 302 can be adjusted as part of electrically reconfiguring the first beamforming component 302 to process electromagnetic waves and beam patterns.

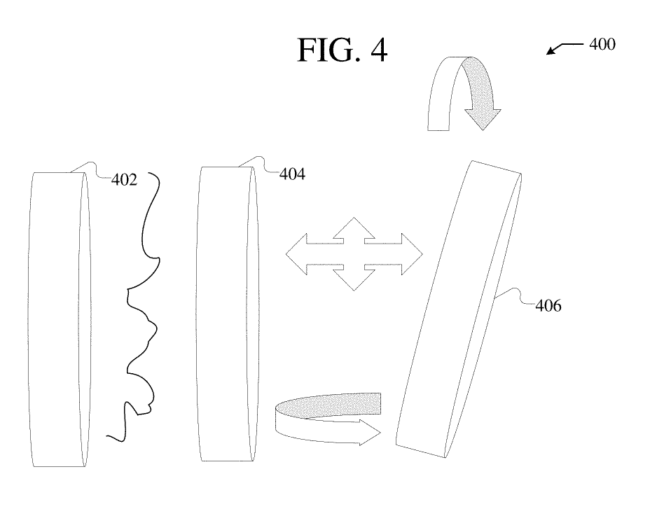

FIG. 4 illustrates an example reconfigurable beamforming apparatus 400 with three beamforming components. The reconfigurable beamforming apparatus 400 functions according to an applicable apparatus for beamforming feed waves, such as the beamforming apparatuses described herein. The reconfigurable beamforming apparatus 400 includes a first beamforming component 402, a second beamforming component 404, and a third beamforming component 406. The first beamforming component 402, the second beamforming component 404, and the third beamforming component 406 function according to applicable beamforming components, such as the corresponding first and second beamforming components described herein. Specifically, the first beamforming component 402 can convert feed waves received at the first beamforming component 402, e.g. from an applicable feed source such as the feed sources described herein, into one or more intermediate beam patterns, as part of beamforming the feed waves. Further, the second beamforming component 404 can convert the one or more intermediate beam patterns into one or more output beam patterns, as part of beamforming the feed waves. Additionally, the third beamforming component 406 can convert the one or more output beam patterns from the second beamforming component into one or more beam patterns changed or modified from the output beam patterns.

In being reconfigurable, the beamforming apparatus 400 can include a reconfigurable arrangement of the first beamforming component 402, the second beamforming component 404, and the third beamforming component 406. Specifically, the third beamforming component 406 is reconfigurable to achieve different beamforming component configuration states as part of the reconfigurable arrangement of the beamforming apparatus 400. In turn, the third beamforming component 406 can generate a specific beam pattern based on a changed beamforming component configuration state of the third beamforming component 406, as part of the reconfigurable arrangement of the beamforming apparatus 400. For example, as will be described in greater detail later, the electrical characteristics of the third beamforming component 406 can be changed in order to convert an output beam pattern received from the second beamforming component 404 into a specific/desired pattern. While the example beamforming apparatus 400 shown in FIG. 4 is only shown with a reconfigurable third beamforming component 406, in various embodiments, either or both the first and second beamforming components 402 and 404 can be reconfigurable beamforming components as well.

The third beamforming component 406 can be controlled, e.g. to achieve a specific arrangement of a reconfigurable arrangement of beamforming component configuration states, to form specific output beam patterns. Specifically, the third beamforming component 406 can be controlled to form a specific far-field beam pattern. For example, the third beamforming component 406 can be controlled to form a pencil beam in a far-field beam pattern. In another example, the third beamforming component 406 can be controlled to form a fan beam in a far-field beam pattern. Further, the third beamforming component 406 can be controlled to form a specific near-field beam pattern. For example, the third beamforming component 406 can be controlled to form a focused beam pattern in a near-field beam pattern.

Further, the third beamforming component 406 can be controlled to ultimately control a main lobe in an output beam pattern generated by the second beamforming component 404. Specifically, the third beamforming component 406 can be controlled to select an angle of a direction of a main lobe in an output beam pattern generated by the second beamforming component 404. Additionally, the third beamforming component 406 can be controlled to select a direction of a main lobe in an output beam pattern generated by the second beamforming component 404.

Additionally, the third beamforming component 406 can be controlled to ultimately control a focal point in an output beam pattern generated by the second beamforming component 404. Specifically, the third beamforming component 406 can be controlled to select a direction towards a focal point in an output beam pattern generated by the second beamforming component 404. Additionally, the third beamforming component 406 can be controlled to select a distance to a focal point, e.g. a focal length, in an output beam pattern generated by the second beamforming component 404.

The third beamforming component 406 can be controlled to ultimately control a focused beam formed by one or more output beam patterns generated by the second beamforming component 404. Specifically, the third beamforming component 406 can be controlled to select a depth of focus of a focused beam in one or more output beam patterns generated by the second beamforming component 404.

Different beamforming component configuration states achievable by the third beamforming component 406, e.g. through reconfiguration of the third beamforming component 406, can be pre-defined beamforming component configuration states. For example, the different beamforming component configuration states can be pre-defined orientations of the third beamforming component 406. Pre-defined beamforming component configuration states of the third beamforming component 406 can be pre-defined based on output beam patterns capable of being received at the third beamforming component 406. Further, pre-defined beamforming component configuration states of the third beamforming component 406 can be pre-defined based on specific output beam patterns capable of being generated by the third beamforming component 406. For example, a pre-defined beamforming component configuration state of the third beamforming component 406 can be defined to create a specific beam pattern based on characteristics of output beam patterns received at the third beamforming component 406.

Pre-defined beamforming component configuration states of the third beamforming component 406 can correspond to different wave holograms, e.g. each pre-defined beamforming component configuration state can correspond to a specific wave hologram. The wave holograms for the pre-defined beamforming component configuration states can be physically embedded in the third beamforming component 406. Further, the third beamforming component 406 can be reconfigured according to the wave holograms physically embedded in the third beamforming component 406 to select a specific output beam pattern. In particular, a specific wave hologram physically embedded in the third beamforming component 406 can be excited in order to select a specific output beam pattern corresponding to the specific wave hologram.

Additionally, one or more output beam patterns created by the second beamforming component 404 can serve as one or more reconstruction beams for a specific wave hologram embedded in the third beamforming component 406. Specifically, an output beam pattern of the second beamforming component 404 can be selected to excite a specific wave hologram embedded in the third beamforming component 406. In turn, a specific beam pattern of the third beamforming component 406 can be selected based on selection of the output beam pattern of the second beamforming component 404 to excite the specific wave hologram of the third beamforming component 406.

The third beamforming component 406 can be mechanically reconfigurable to achieve different beamforming component configuration states. Specifically, the third beamforming component 406 can be electromechanically reconfigurable to mechanically reconfigure the third beamforming component 406. For example, an electric field can be applied to the third beamforming component 406 to mechanically reconfigure the third beamforming component 406. Additionally, the third beamforming component 406 can include one or more mechanically configurable elements for mechanically reconfiguring the third beamforming component 406 to achieve different beamforming component configuration states. For example, the third beamforming component 406 can include one or more motors and gears for changing an orientation of the third beamforming component 406. The one or more mechanically configurable elements can have adjustable complex impedances, e.g. electric or acoustic impedances, which are varied for mechanically reconfiguring the third beamforming component 406. For example, a complex impedance of a mechanically configurable element of the third beamforming component 406 can be adjusted to cause the third beamforming component 406 to pivot about a point.

An orientation of the third beamforming component 406 within the beamforming apparatus 400 can be changed in order to mechanically reconfigure the third beamforming component 406. Specifically, an orientation of the third beamforming component 406 with respect to the second beamforming component 404 can be changed to mechanically reconfigure the third beamforming component 406 to achieve different beamforming component configuration states. An orientation of the third beamforming component 406 with respect to the second beamforming component 404 can be changed by either or both rotating the third beamforming component 406 and displacing the third beamforming component 406. For example, the third beamforming component 406 can be rotated towards the second beamforming component 404 in order to change an orientation of the third beamforming component 406, e.g. as part of mechanically reconfiguring the third beamforming component 406.

An orientation of the third beamforming component 406 within the beamforming apparatus 400 can be changed using an applicable displacement or rotation mechanism. Specifically, an orientation of the third beamforming component 406 with respect to the second beamforming component 404 can be changed using an applicable rotation or displacement mechanism. For example, an orientation of the third beamforming component 406 can be changed based on electromechanically reconfigurable characteristics of the third beamforming component 406 and/or mechanically configurable elements of the third beamforming component 406.

The third beamforming component 406 can be electrically reconfigurable to achieve different beamforming component configuration states. Specifically, the third beamforming component 406 can include one or more electrically configurable elements for electrically reconfiguring the third beamforming component 406 to achieve different beamforming component configuration states. More specifically, electrically configurable elements can include metamaterial elements that can be electrically manipulated to reconfigure the third beamforming component 406. For example, voltages can be applied to metamaterial elements of the third beamforming component 406 to change electrical characteristics of the elements. Further in the example, this can change overall electrical characteristics of the third beamforming component 406, e.g. as part of electrically reconfiguring the third beamforming component 406.

Further, complex impedances of electrically configurable elements of the third beamforming component 406 can be adjusted in order to electrically reconfigure the third beamforming component 406. For example, acoustic impedances of the electrically configurable elements of the third beamforming component 406 can be adjusted as part of electrically reconfiguring the third beamforming component 406 to process acoustic waves and beam patterns. In another example, electric impedances of the electrically configurable elements of the third beamforming component 406 can be adjusted as part of electrically reconfiguring the third beamforming component 406 to process electromagnetic waves and beam patterns.

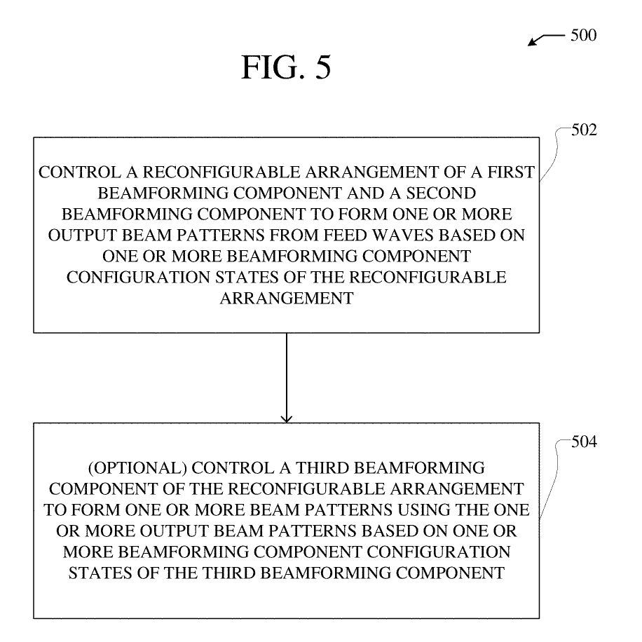

FIG. 5 is a flowchart 500 of an example method of controlling one or more beamforming components in a beamforming apparatus to convert feed waves into one or more output beam patterns. At step 502, a reconfigurable arrangement of a first beamforming component and a second beamforming component are controlled to form one or more output beam patterns from feed waves based on one or more beamforming component configuration states of the reconfigurable arrangement. Specifically, the first beamforming component can be controlled to receive feed waves from a feed source and generate one or more intermediate beam patterns from the feed waves. More specifically, the first beamforming component can be controlled to generate the one or more intermediate beam patterns based on a beamforming component configuration state of the first beamforming component forming part of the reconfigurable arrangement. Further, the second beamforming component can be controlled to receive the one or more intermediate beam patterns from the first beamforming component and generate the one or more output beam patterns. Specifically, the second beamforming component can be controlled to generate the one or more output beam patterns based on a beamforming component configuration state of the second beamforming component forming part of the reconfigurable arrangement.

In generating the output beam patterns based on the reconfigurable arrangement of the first beamforming component and the second beamforming component, the second beamforming component can generate the output beam patterns based on a component configuration state of both the first beamforming component and the second beamforming configuration. Specifically, the first beamforming component can generate specific intermediate beam patterns based on a component configuration state of the first beamforming component. As follows, the second beamforming component can generate the output beam patterns based on the specific intermediate beam patterns, e.g. the component configuration state of the first beamforming component, and a beamforming component configuration state of the second beamforming component.

In various embodiments, the first beamforming component can remain in a static component configuration state while the second beamforming component is reconfigured to a different component configuration state, as part of controlling the reconfigurable arrangement. In turn, as part of generating the output beam patterns based on the reconfigurable arrangement, the second beamforming component can generate the output beam patterns based on the first beamforming component having a static component configuration state and the second beamforming component having a variable component configuration state. Alternatively, the second beamforming component can remain in a static component configuration state while the first beamforming component is reconfigured to a different component configuration state, as part of controlling the reconfigurable arrangement. In turn, as part of generating the output beam patterns based on the reconfigurable arrangement, the second beamforming component can generate the output beam patterns based on the second beamforming component having a static component configuration state and the first beamforming component having a variable component configuration state.

At optional step 504, a third beamforming component of the reconfigurable arrangement is controlled to form one or more beam patterns using the one or more output beam patterns. Specifically, the third beamforming component of the reconfigurable arrangement can receive the output beam patterns from the second beamforming component and convert the output beam patterns into one or more beam patterns. The third beamforming component can be controlled to generate the one or more beam patterns based on a component configuration state of the third beamforming component. For example, the third beamforming component can be controlled by keeping the third beamforming component in a static beamforming component configuration state to generate the one or more beam patterns. Alternatively, the third beamforming component can be controlled by reconfiguring a beamforming configuration state of the third beamforming component to generate the one or more beam patterns.

The beamforming apparatuses described herein can include an external control mechanism for controlling a reconfigurable arrangement of the beamforming components in the beamforming apparatuses. Specifically, the external control mechanism can control an orientation of one or a combination of the beamforming components in the beamforming apparatuses. More specifically, the external control mechanism can control an orientation of a first beamforming component, a second beamforming component, and/or a third beamforming component in a beamforming apparatus. The external control mechanism can control an orientation of a first beamforming component and a second beamforming component with respect to each other. For example, the external control mechanism can be controlled to cause the second beamforming component to rotate towards the first beamforming component. In various embodiments, the external control mechanism can include a screw that is manually controllable by a user of a beamforming apparatus. Specifically, a user can manually operate the screw to change an orientation of either or both a first beamforming component and a second beamforming component. This can allow the user to customize the beamforming apparatus for their own needs, e.g. tilting the beamforming apparatus towards a transceiver.

In various embodiments, the beamforming apparatuses described herein can be controlled for performing imaging. Specifically, the beamforming apparatuses can be controlled for performing coded aperture imaging using one or more output beam patterns. Further, the beamforming apparatuses can be controlled for performing radar imaging using one or more output beam patterns. Additionally, the beamforming apparatuses can be controlled for performing sonar imaging using one or more output beam patterns.

In certain embodiments, the beamforming apparatuses described herein can form an antenna. Specifically, the beamforming apparatuses can form a radar antenna. Further, the beamforming apparatuses can form a direction-tracking receiving antenna. Additionally, the beamforming apparatuses can form a directional transmitter antenna.

In various embodiments, the beamforming apparatuses described herein can form a sonar transducer, a directional microphone, or a directional speaker. In certain embodiments, the beamforming apparatuses described herein can form an ultrasound beam generator.

As discussed previously, the beamforming apparatuses described herein can function as a wireless power transmitter for transmitting power wirelessly to a wireless power receiver. In functioning as a wireless power transmitter, the beamforming components can be controlled to deliver power wirelessly to a wireless power receiver according to a prescribed path that the wireless power receiver traverses. Specifically, beamforming components can be controlled to generate one or more output beam patterns that follow a prescribed path of a wireless power receiver. The one or more output beam patterns can comprise a series of far-field pencil beams that each intersect in the prescribed path of the wireless power receiver. Further, the one or more output beam patterns can comprise a series of focus beams that each have a focal point on the prescribed path of the wireless power receiver.

In various embodiments, all or portions of the beamforming components of the beamforming apparatuses described herein can be either translucent in the visible spectrum or substantially transparent in the visible spectrum. Specifically, the beamforming components can comprise materials that are either translucent or substantially transparent in the visible spectrum. This can allow for light to pass through the beamforming apparatuses when installed at a location. For example, a beamforming apparatus can be installed in a roof of a house and also serve as a skylight by allowing light to pass through beamforming apparatus into the house.

While the beamforming components are described with reference to metamaterials, in various embodiments the beamforming components can comprise applicable materials for generating beam patterns based on various beamforming component configuration states of the beamforming components. Specifically, in various embodiments, the beamforming components can be fabricated, at least in part, from polymer-based binary composite structures. Further, the beamforming components can be fabricated from applicable materials based on volumetric distributions of dielectric particles.

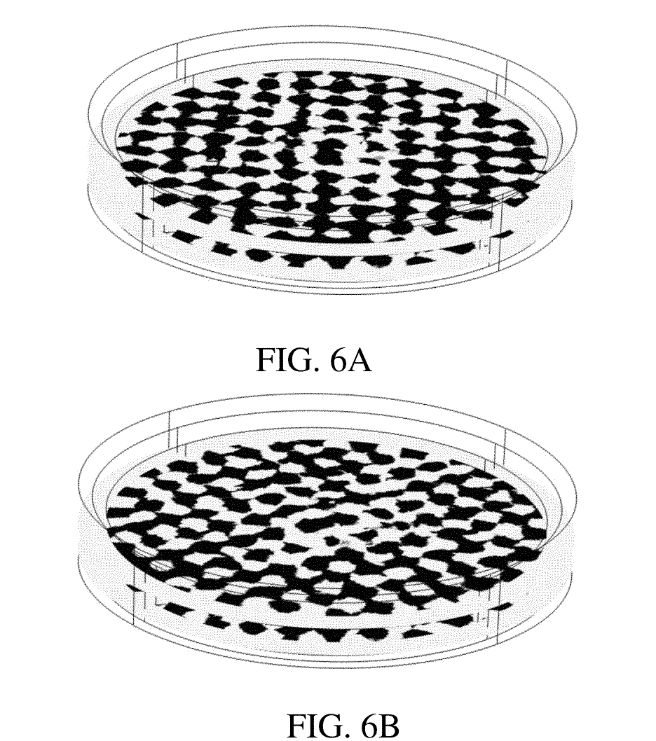

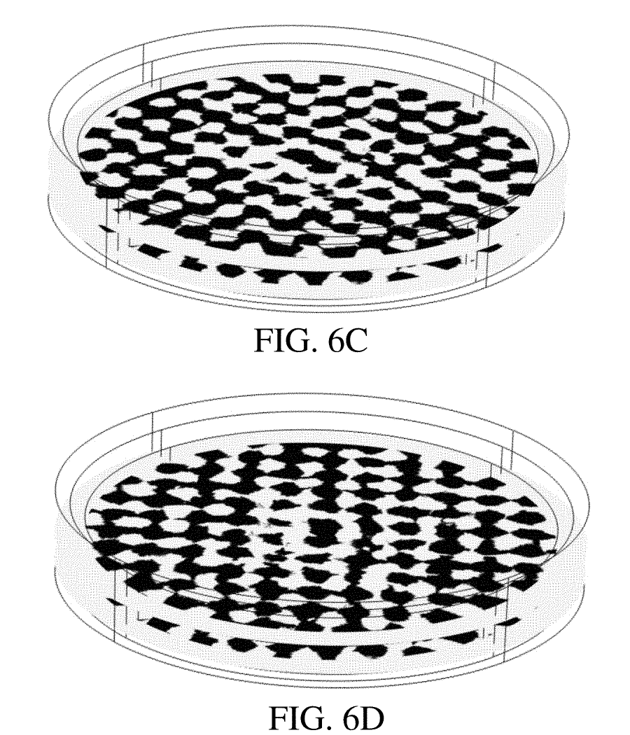

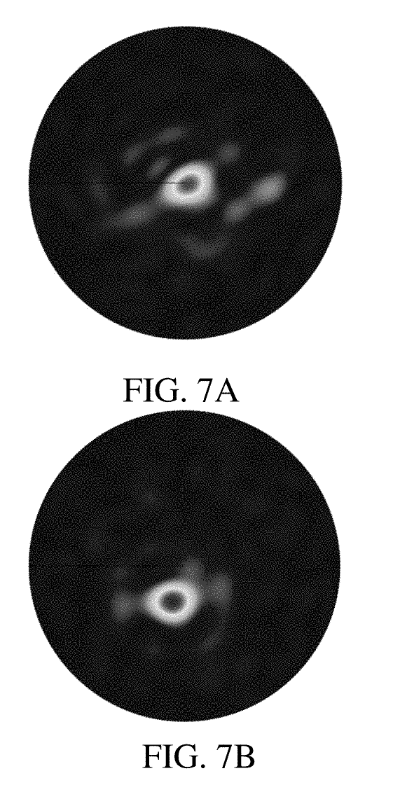

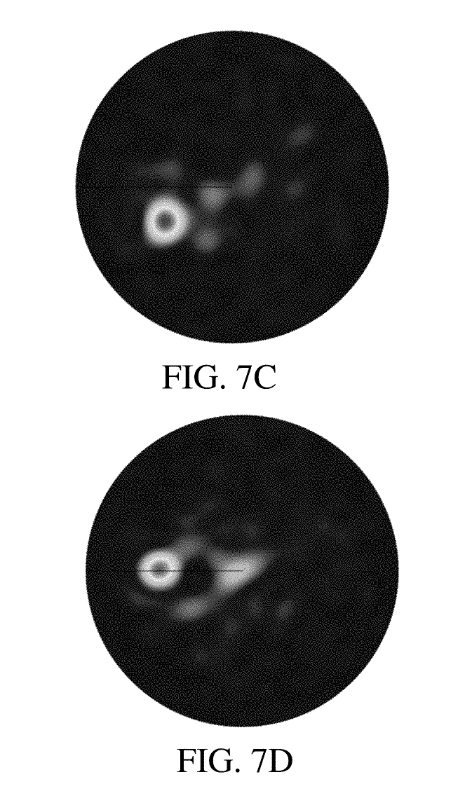

FIGS. 6A-6D show a view of a beamforming component as the beamforming component is rotated. Specifically, FIGS. 6A-6D show a view of a beamforming component as the beamforming component is rotated 180°. The beamforming component shown in FIGS. 6A-6D can be an applicable beamforming component of an applicable beamforming apparatus, such as the beamforming components of the beamforming apparatuses described herein. For example, the beamforming component shown in FIGS. 6A-6D can be either a first beamforming component or a second beamforming component of a beamforming apparatus. The beamforming component shown in FIGS. 6A-6D is rotated to change the beamforming component configuration state of the beamforming component as part of reconfiguring the beamforming component, e.g. in controlling the beamforming component for beamforming feed waves. This rotation can control an output beam pattern generated using the beamforming component. Specifically, FIGS. 7A-7D show the corresponding far field output beam pattern created using the beamforming component of FIGS. 6A-6D as the beamforming component is rotated, as shown in FIGS. 6A-6D. In particular, as the beamforming component is rotated, the far field output beam pattern changes, e.g. as part of beamforming feed waves using the beamforming apparatuses described herein.

This disclosure has been made with reference to various exemplary embodiments including the best mode. However, those skilled in the art will recognize that changes and modifications may be made to the exemplary embodiments without departing from the scope of the present disclosure. For example, various operational steps, as well as components for carrying out operational steps, may be implemented in alternate ways depending upon the particular application or in consideration of any number of cost functions associated with the operation of the system, e.g., one or more of the steps may be deleted, modified, or combined with other steps.

While the principles of this disclosure have been shown in various embodiments, many modifications of structure, arrangements, proportions, elements, materials, and components, which are particularly adapted for a specific environment and operating requirements, may be used without departing from the principles and scope of this disclosure. These and other changes or modifications are intended to be included within the scope of the present disclosure.

The foregoing specification has been described with reference to various embodiments. However, one of ordinary skill in the art will appreciate that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “comprises,” “comprising,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

Those having skill in the art will appreciate that many changes may be made to the details of the above-described embodiments without departing from the underlying principles of the invention. The scope of the present invention should, therefore, be determined only by the following claims.

What is claimed is:

1. An apparatus for beamforming feed waves comprising:
a reconfigurable arrangement of a first beamforming component and a second beamforming component, wherein:
the first beamforming component is configured to convert the feed waves received at the first beamforming component from a feed source into one or more intermediate beam patterns; and
the second beamforming component is configured to convert the one or more intermediate beam patterns received at the second beamforming component from the first beamforming component into one or more output beam patterns based on one or more beamforming component configuration states of the reconfigurable arrangement.

2. The apparatus of claim 1, wherein the second beamforming component is reconfigurable to achieve different second beamforming component configuration states that are pre-defined beamforming component configuration states for converting the one or more intermediate beam patterns into specific output beam patterns.

3. The apparatus of claim 2, wherein the second beamforming component configuration states correspond to a plurality of wave holograms physically embedded in the second beamforming component and the second beamforming component is reconfigurable according to a wave hologram of the wave holograms to select a specific output beam pattern of the specific output beam patterns by exciting a specific wave hologram stored within the second beamforming component.

4. The apparatus of claim 3, wherein an intermediate beam created by the first beamforming component serves as a reconstruction beam for a wave hologram physically embedded in the second beamforming component.

5. The apparatus of claim 3, wherein the first beamforming component is reconfigurable to achieve different first beamforming component configuration states according to the wave holograms to select a specific output beam pattern of the specific output beam patterns by exciting a specific wave hologram stored within the second beamforming component.

6. The apparatus of claim 3, wherein the first beamforming component is reconfigurable to achieve different first beamforming component configuration states according to the wave holograms to select a specific intermediate beam pattern of variable intermediate beam patterns in order to select the specific output beam pattern of the specific output beam patterns.

7. The apparatus of claim 6, wherein the second beamforming component remains static in a second beamforming component configuration state and the specific intermediate beam pattern of the variable intermediate beam patterns is selected to retrieve a specific wave hologram of the wave holograms for the second beamforming component to select the specific output beam pattern of the specific output beam patterns.

8-31. (canceled)

32. The apparatus of claim 1, wherein either or both the first beamforming component is reconfigurable to achieve different first beamforming component configuration states of the reconfigurable arrangement to convert the feed waves received at the first beamforming component into the one or more intermediate beam patterns based on the different first beamforming component configuration states and the second beamforming component is reconfigurable to achieve different second beamforming component configuration states of the reconfigurable arrangement to convert the one or more intermediate beam patterns into the one or more output beam patterns based on the different second beamforming component configuration states and further wherein each first beamforming component configuration state corresponds to a frequency-domain mode for the first beamforming component and each second beamforming component configuration state corresponds to a frequency-domain mode for the second beamforming component of one or more frequencies of the feed waves.

33-39. (canceled)

40. The apparatus of claim 1, wherein the feed waves are acoustic waves.

41-43. (canceled)

44. The apparatus of claim 1, wherein the second beamforming component is reconfigurable to achieve different second beamforming component configuration states of the reconfigurable arrangement to convert the intermediate beam patterns received at the second beamforming component into the one or more output beam patterns based on the different second beamforming component configuration states.

45. The apparatus of claim 44, wherein the second beamforming component is mechanically reconfigurable to achieve the different second beamforming component configuration states of the reconfigurable arrangement.

46-52. (canceled)

53. The apparatus of claim 44, wherein the second beamforming component is electrically reconfigurable to achieve the different second beamforming component configuration states of the reconfigurable arrangement.

54-56. (canceled)

57. The apparatus of claim 1, wherein the first beamforming component is reconfigurable to achieve different first beamforming component configuration states of the reconfigurable arrangement to convert the feed waves received at the first beamforming component into the one or more intermediate beam patterns based on the different first beamforming component configuration states.

58. The apparatus of claim 57, wherein the first beamforming component is mechanically reconfigurable to achieve the different first beamforming component configuration states.

59-65. (canceled)

66. The apparatus of claim 57, wherein the first beamforming component is electrically reconfigurable to achieve the different first beamforming component configuration states.

67-69. (canceled)

70. The apparatus of claim 57, wherein the first beamforming component configuration states are pre-defined beamforming component configuration states for converting the feed waves into specific intermediate beam patterns.

71. The apparatus of claim 70, wherein the first beamforming component configuration states are stored as wave holograms for the first beamforming component and the first beamforming component is reconfigured according to the wave holograms to select a specific intermediate beam pattern of the specific intermediate beam patterns.

72-94. (canceled)

95. The apparatus of claim 1, further comprising a fluid disposed between the first beamforming component and the second beamforming component.

96-99. (canceled)

100. The apparatus of claim 1, further comprising a third beamforming component reconfigurable to achieve different third beamforming component configuration states to convert the one or more output beam patterns received at the third beamforming component from the second beamforming component into one or more beam patterns based on the different third beamforming component configuration states.

101. The apparatus of claim 100, wherein the third beamforming component is mechanically reconfigurable to achieve the different third beamforming component configuration states.

102-108. (canceled)

109. The apparatus of claim 100, wherein the third beamforming component is electrically reconfigurable to achieve the different third beamforming component configuration states.

110-143. (canceled)

144. A method for beamforming feed waves comprising:
controlling a reconfigurable arrangement of a first beamforming component and a second beamforming component to form one or more output beam patterns from the feed waves based on one or more beamforming component configuration states of the reconfigurable arrangement, by controlling the first beamforming component to convert the feed waves received at the first beamforming component from a feed source into one or more intermediate beam patterns and controlling the second beamforming component to convert the one or more intermediate beam patterns received at the second beamforming component from the first beamforming component into the one or more output beam patterns based on the reconfigurable arrangement.

145. The method of claim 144, wherein the second beamforming component is reconfigurable to achieve different second beamforming component configuration states that are pre-defined beamforming component configuration states for converting the one or more intermediate beam patterns into specific output beam patterns.

146. The method of claim 145, wherein the second beamforming component configuration states correspond to a plurality of wave holograms physically embedded in the second beamforming component and the second beamforming component is reconfigurable according to a wave hologram of the wave holograms to select a specific output beam pattern of the specific output beam patterns by exciting a specific wave hologram stored within the second beamforming component.

147. The method of claim 146, wherein an intermediate beam created by the first beamforming component serves as a reconstruction beam for a wave hologram physically embedded in the second beamforming component.

148. The method of claim 146, wherein the first beamforming component is reconfigurable to achieve different first beamforming component configuration states according to the wave holograms to select a specific output beam pattern of the specific output beam patterns by exciting a specific wave hologram stored within the second beamforming component.

149. The method of claim 146, wherein the first beamforming component is reconfigurable to achieve different first beamforming component configuration states according to the wave holograms to select a specific intermediate beam pattern of variable intermediate beam patterns in order to select the specific output beam pattern of the specific output beam patterns.

150. The method of claim 149, wherein the second beamforming component remains static in a second beamforming component configuration state and the specific intermediate beam pattern of the variable intermediate beam patterns is selected to retrieve a specific wave hologram of the wave holograms for the second beamforming component to select the specific output beam pattern of the specific output beam patterns.

151-174. (canceled)

175. The method of claim 144, wherein either or both the first beamforming component is reconfigurable to achieve different first beamforming component configuration states of the reconfigurable arrangement to convert the feed waves received at the first beamforming component into the one or more intermediate beam patterns based on the different first beamforming component configuration states and the second beamforming component is reconfigurable to achieve different second beamforming component configuration states of the reconfigurable arrangement to convert the one or more intermediate beam patterns into the one or more output beam patterns based on the different second beamforming component configuration states and further wherein each first beamforming component configuration state corresponds to a frequency-domain mode for the first beamforming component and each second beamforming component configuration state corresponds to a frequency-domain mode for the second beamforming component of one or more frequencies of the feed waves.

176. The method of claim 144, wherein the feed waves are electromagnetic waves.

177-182. (canceled)

183. The method of claim 144, wherein the feed waves are acoustic waves.

184-186. (canceled)

187. The method of claim 144, wherein the second beamforming component is reconfigurable to achieve different second beamforming component configuration states of the reconfigurable arrangement to convert the intermediate beam patterns received at the second beamforming component into the one or more output beam patterns based on the different second beamforming component configuration states.

188. The method of claim 187, wherein the second beamforming component is mechanically reconfigurable to achieve the different second beamforming component configuration states of the reconfigurable arrangement.

189-195. (canceled)

196. The method of claim 187, wherein the second beamforming component is electrically reconfigurable to achieve the different second beamforming component configuration states of the reconfigurable arrangement.

197-199. (canceled)

200. The method of claim 144, wherein the first beamforming component is reconfigurable to achieve different first beamforming component configuration states of the reconfigurable arrangement to convert the feed waves received at the first beamforming component into the one or more intermediate beam patterns based on the different first beamforming component configuration states.

201. The method of claim 200, wherein the first beamforming component is mechanically reconfigurable to achieve the different first beamforming component configuration states.

202-208. (canceled).

209. The method of claim 200, wherein the first beamforming component is electrically reconfigurable to achieve the different first beamforming component configuration states.

210-212. (canceled)

213. The method of claim 200, wherein the first beamforming component configuration states are pre-defined beamforming component configuration states for converting the feed waves into specific intermediate beam patterns.

214. The method of claim 213, wherein the first beamforming component configuration states are stored as wave holograms for the first beamforming component and the first beamforming component is reconfigured according to the wave holograms to select a specific intermediate beam pattern of the specific intermediate beam patterns.

215-242. (canceled)

243. The method of claim 144, further comprising controlling a third beamforming component reconfigurable to achieve different third beamforming component configuration states to convert the one or more output beam patterns received at the third beamforming component from the second beamforming component into one or more beam patterns based on the different third beamforming component configuration states.

244. The method of claim 243, wherein the third beamforming component is mechanically reconfigurable to achieve the different third beamforming component configuration states.

245-251. (canceled)

252. The method of claim 243, wherein the third beamforming component is electrically reconfigurable to achieve the different third beamforming component configuration states.

253-286. (canceled)
